(19) United States
(12) Patent Application Publication
(10) Pub. No.: US 2012/0246572 A1
(43) Pub. Date: Sep. 27, 2012

(54) SYSTEM AND METHOD FOR CHANGING INTERFACE SKIN

(75) Inventor: Qiang TU, Shenzhen City (CN)

(73) Assignee: TENCENT TECHNOLOGY (SHENZHEN) COMPANY LIMITED, Shenzhen City (CN)

(21) Appl. No.: 13/487,379

(22) Filed: Jun. 4, 2012

Related U.S. Application Data
(63) Continuation of application No. PCT/CN2011/070319, filed on Jan. 17, 2011.

(30) Foreign Application Priority Data
Jan. 20, 2010 (CN) 201010102030.5

(51) Int. Cl. G06F 3/01; G06F 15/16

(52) U.S. Cl. 715/747

(57) ABSTRACT

The embodiments of the present invention provide a system and a method for changing interface skin. The system includes: a skin package server, configured to store skin package data; and a client, configured to send a query request to the skin package server periodically, obtain information related to a newly added skin package, initiate a downloading request to the skin package server according to selection of a user to download the skin package data, and change interface skin according to the downloaded skin package data. By the system and method for changing interface skin provided by the embodiments of the present invention, the skin package newly added in the skin package server may be obtained timely, and it do not need to restart the application program, so as to change interface skin conveniently and timely.

### FIELD OF THE INVENTION

The present invention relates to communication technologies, and particularly to a system and a method for changing interface skin.

### BACKGROUND OF THE INVENTION

With the development of graphical technologies, interfaces of current operation systems become visual increasingly, and interaction modes adopted by the operation systems are more and more similar to actual interaction modes of users. Representation of basic interface elements of Windows operation system includes a title bar, font, letter color, a window background, a menu, buttons, background of other controls and so on, and a set of these interface elements is called skin. The interface representation of Windows application programs keeps identical with that of Windows operation system in default, i.e., skin representation of the application programs is identical with that of the operation system.

As application software is applied to more and more application fields, software with special purposes usually needs special interaction and user interface, and users need to personalize and customize interfaces. An application program configures each interface element and provides functions for changing and customizing, which is called as “changing skin”. Generally, an application program supporting “changing skin” provides multiple pieces of skin to be selected by users. After a certain piece of skin is selected by a user, the interface representation of the application program becomes different from that of the system immediately, so as to meet the requirements of personalized interface.

A conventional method for “changing skin” includes, after selecting a certain piece of skin through a skin package management and an entry of application, exiting and restarting the application program, and after restarting the application program, loading and using the selected skin, so as to change the interface skin. In the conventional method, the new skin does not become valid until the application program is restarted, thus the conventional method is inconvenient and untimely, and may not provide rich interface representation abilities.

### SUMMARY OF THE INVENTION

In one aspect of the invention, a system for changing interface skin is provided, including:

a skin package server, to store a skin package; and

a client, to send a query request to the skin package server periodically, obtain information related to a newly added skin package, initiate a downloading request to the skin package server according to selection of a user to download a skin package stored in the skin package server, and change interface skin according to a downloaded skin package.

In another aspect of the invention, the client is further to create an interface element according to the downloaded skin package, and store the created interface element in local, wherein the client changes the interface skin without restarting a application program.

In another aspect of the invention, a method for changing interface skin is provided, including:

sending a query request periodically, and obtaining information related to a newly added skin package;

initiating a downloading request according to selection of a user to download a skin package stored in the skin package server; and

changing the interface skin according to a downloaded skin package.

In another aspect of the invention, before changing the interface skin according to the downloaded skin package, the method further includes:

creating an interface element according to the downloaded skin package, and storing the created interface element in local;

wherein the interface skin is changed without restarting a application program.

### BRIEF DESCRIPTION OF THE DRAWINGS

FIG. 1 is a schematic diagram illustrating a system for changing interface skin according to the present invention;

FIG. 2 is a schematic diagram illustrating structure of a skin package server according to an embodiment of the present invention;

FIG. 3 is a schematic diagram illustrating structure of a client according to an embodiment of the present invention;

FIG. 4 is a schematic diagram illustrating structure of a skin changing module according to an embodiment of the present invention;

FIG. 5 is a flowchart illustrating a method for changing interface skin according to an embodiment of the present invention.

### DETAILED DESCRIPTION OF THE INVENTION

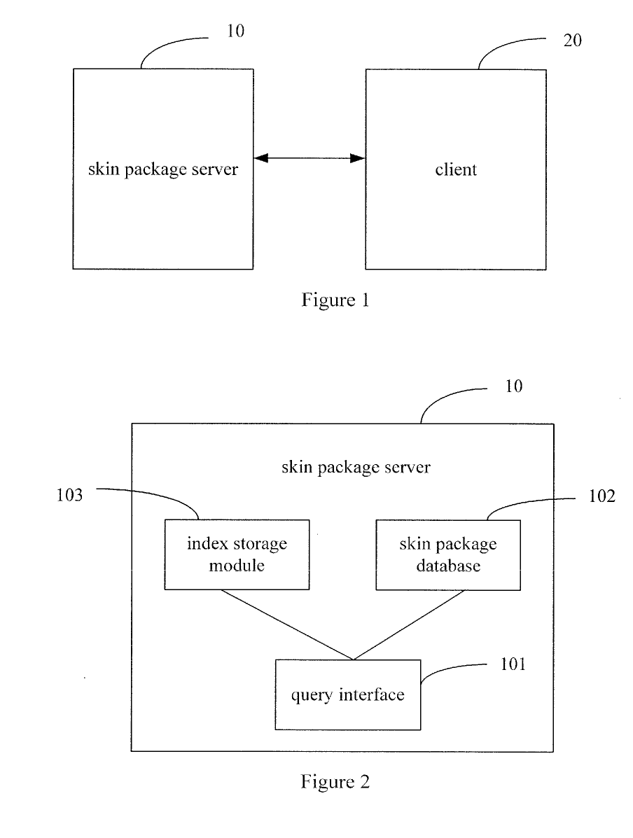

FIG. 1 is a schematic diagram illustrating a system for changing interface skin according to the present invention. The system includes a skin package server 10 and a client 20.

The skin package server 10 stores skin package data. The skin package data include preview pictures and names of skin, IDs of skin packages, skin resource file data etc. As shown in FIG. 2, in an embodiment, the skin package server 10 includes a query interface 101, a skin package database 102 and an index storage module 103.

The query interface 101 is adapted to receive a query request and a downloading request sent by the client 20 and return skin package data to the client 20. The skin package database 102 is adapted to store all skin package data, and the index storage module 103 is adapted to store index information of skin package data. In an embodiment, the index information recorded by the index storage module 103 includes the IDs, names and preview pictures of skin packages and time stamps of uploading the skin packages to the skin package database 102, etc.

The client 20 is adapted to send the query request to the skin package server 10 periodically, obtain information related to newly added skin package, initiate the downloading request to the skin package server 10 to download the skin package data, and change skin according to the downloaded skin package data. In an embodiment, as shown in FIG. 3, the client 20 includes a query module 201, a local storage module 202, a selecting module 203 and a skin changing module 204.

The query module 201 is adapted to send the query request and the downloading request to the skin package server 10, and receive the skin package data returned by the skin package server 10. In an embodiment, the query module 201 may send the query request to the skin package server 10 according to a preset time interval to query whether there is a newly added skin package or not. Specifically, the skin package server 10 is queried according to the time stamp recorded by the index storage module 103, and the skin package which is newly added in the skin package database 102 during an interval between two queries may be obtained according to the time stamp. When determining, through querying, that there is a newly added skin package, the query module 201 returns the index information of the newly added skin package to the client 20.

The local storage module 202 is adapted to store all downloaded skin package data. In an embodiment, after the query module 201 of the client 20 determines, through querying, that there is a newly added skin package, the client 20 stores the index information of the newly added skin package in the local storage module 202. The information related to all skin packages stored in the local storage module 202 may be displayed to the user, so as to be selected by the user. If the user selects a piece of skin which has not been downloaded, the query module 201 initiates a downloading request for downloading skin package data to the skin package server 10, and the downloaded skin package data are stored in the local storage module 202.

The selecting module 203 is adapted to display the information related to the skin packages stored in the local storage module 202, so as to be selected by the user. In an embodiment, the selecting module 203 may display the preview pictures, names and IDs of locally stored skin packages to the user, so as to be selected by the user.

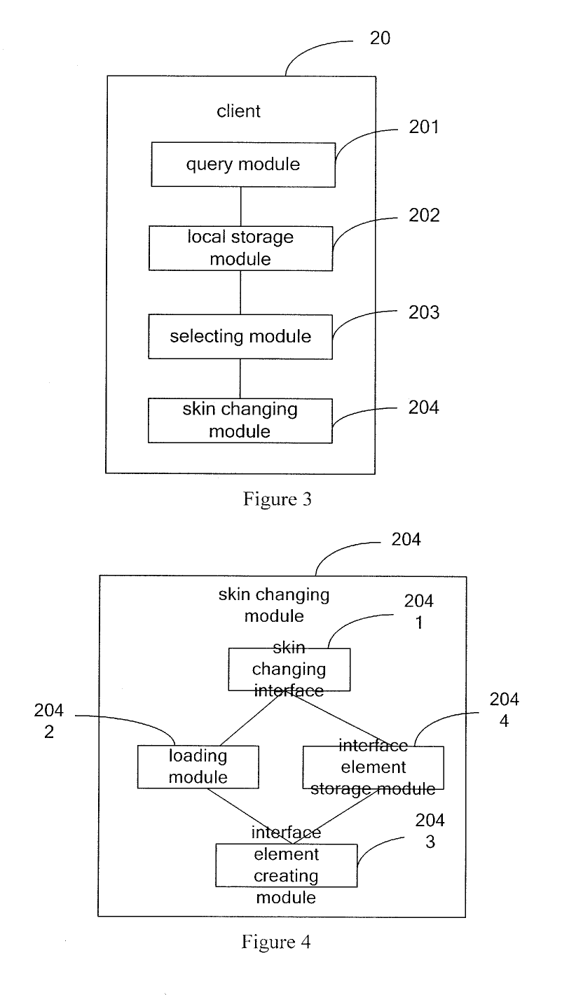

The skin changing module 204 is adapted to change skin according to the selection of the user. In an embodiment, the user selects a skin package through the selecting module 203, e.g., presses the preview picture of the skin package on the interface. If the local storage module 202 does not store the skin package data selected by the user, the query module 201 of the client 20 initiates a downloading request for downloading the skin package to the skin package server 10, and the query interface 101 of the skin package sever 10 obtains the skin package data from the skin package database 102 and returns the skin package data to the client 20. The query module 201 of the client 20 may store the skin package data in the local storage module 202 after receiving the skin package data, at the same time, the skin changing module 204 changes skin according to the obtained skin package data. As shown in FIG. 4, in an embodiment, the skin changing module 204 includes a skin changing interface 2041, a loading module 2042, an interface creating module 2043 and an interface element storage module 2044.

The skin changing interface 2041 is adapted to process a skin changing request according to the selection of the user. In an embodiment, the user selects, through the selecting module 203, a skin package to be used, the client 20 downloads the skin package data from the skin package server 10, and the skin changing interface 2041 processes the skin changing request from the user according to the skin package selected by the user and notifies the loading module 2042.

The loading module 2042 loads the skin package data designated by the skin changing request, where the skin package data are taken as skin resources. The skin resources include pictures, font, color, etc.

The interface creating module 2043 creates interface elements according to the skin resources loaded by the loading module 2042. In an embodiment, the interface creating module 2043 obtains resources such as pictures, font and color from the skin resources, so as to change skin. After the interface elements are created, the user confirms to change interface skin (e.g., presses an “apply” button on the interface), so as to implement the interface skin changing operation.

The interface element storage module 2044 is adapted to store all created interface elements. In an embodiment, the interface creating module 2043 is further adapted to manage (e.g., create, delete and so on) the interface elements stored in the interface element storage module 2044.

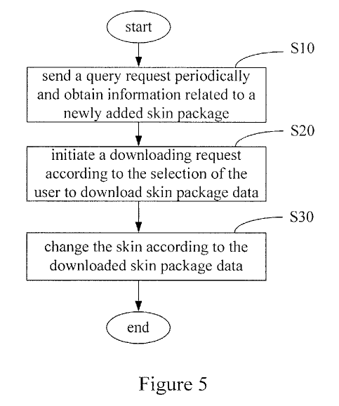

FIG. 5 is a flowchart illustrating a method for changing interface skin according to an embodiment of the present invention. The method includes the following blocks.

In block S10, a query request is sent periodically and information related to a newly added skin package is obtained. In an embodiment, the skin package server 10 stores skin package data. The skin package data include preview pictures, names and IDs of skin packages, as well as skin resource file data, etc. The skin package server 10 also records index information of skin package data, and the index information includes IDs, names and preview pictures of the skin packages and time stamps of uploading the skin packages to the skin package database 102. In an embodiment, before obtaining the information related to the newly added skin package, the method further includes recording the index information of the skin package data. Specifically, obtaining the information related to the newly added skin package includes obtaining the information related to the newly added skin package according to the index information of the skin package data.

In an embodiment, the client 20 sends the query request to the skin package server 10 periodically, obtains the information related to the newly added skin package. In an embodiment, the index information of the skin package data includes time stamps of uploading skin packages to the skin package database. Specifically, the information related to the skin package which is newly added in the skin package database 102 during an interval between two queries is obtained according to a time stamp of uploading the skin package to the skin package database 102. When it is determined, through querying, that there is the information related to the newly added skin package, the index information of the newly added skin package is returned to the index storage module 103.

In block S20, a downloading request is initiated according to the selection of the user to download skin package data. In an embodiment, the client 20 obtains the information related to the skin package newly added in the skin package server 10 and stores the information related to the skin package in the local storage module 202. All information related to the skin packages stored in the local storage module 202 is displayed to the user through the interface, so as to be selected by the user. When the user selects a skin package to be used (e.g., presses a displayed preview picture of a skin package), if the local storage module 202 does not store the skin package data, the client 20 initiates a downloading request for downloading the skin package data to the skin package server 10, and downloads the skin package data from the skin package database 102, and the skin changing module 204 changes interface skin according to the obtained skin package data. The downloaded skin package data are stored in the local storage module 202.

In block S30, the skin is changed according to the downloaded skin package data. In an embodiment, a skin changing request is processed according to the selection of the user, and the skin package data selected by the user are loaded, where the skin package data are taken as skin resources. The skin resources include pictures, font, color, etc. Interface elements are created according to the loaded skin resources, so as to change interface skin. The created interface elements are stored in the interface element storage module 2044. All interface elements stored in the interface element storage module 2044 may be created and deleted. In an embodiment, after the interface skin is changed, the user may press an “apply” button on the interface to change the interface skin.

In the above-mentioned system and method for changing interface skin, through sending a query request to the skin package server periodically, the information related to newly added skin package is obtained, and through sending a downloading request to the skin package server, the skin package data are downloaded, and thus, the skin may be changed according to the downloaded skin package data. Since, through the system and method, the skin package newly added in the skin package server may be obtained, the interface skin may be changed conveniently and timely.

In addition, through managing and maintaining the skin package data by the skin package server, the client may obtain a new skin package after the new skin package is added in the skin package server, so that the client may obtain the information related to the newest skin package at any moment, download the skin package from the skin package server and store the skin package in the local, and thus the user may select personalized skin package data through the client. Since the interface elements created according to the obtained skin package data are stored in the local, without restarting the application program, the user may select again and again, through a selecting module, the skin to be used to change the interface skin. In this way, rich interface representation is obtained, so as to meet the requirements of user's experiences.

The foregoing is only several embodiments of the present invention. The embodiments are described in detail, but the protection scope of the present invention is not limited to these. It should be noted that, any modification and improvement without departing from the principle of the present invention made by those skilled in the art should be covered in the protection scope of the present invention. And thus, the protection scope of the present invention should be defined by the claims.

What is claimed is:

1. A system for changing interface skin, comprising:
a skin package server, to store a skin package; and
a client, to send a query request to the skin package server periodically, obtain information related to a newly added skin package, initiate a downloading request to the skin package server according to selection of a user to download a skin package stored in the skin package server, and change interface skin according to a downloaded skin package.

2. The system of claim 1, wherein the client is further to create an interface element according to the downloaded skin package, and store the created interface element in local, wherein the client changes the interface skin without restarting a application program.

3. The system of claim 1, wherein the skin package server comprises:
a query interface, to receive the query request and the downloading request sent by a client, and return the skin package to the client;
a skin package database, to store the skin package; and
an index storage module, to record index information of the skin package.

4. The system of claim 3, wherein the index storage module is further to record a time stamp of uploading the newly added skin package to the skin package database.

5. The system of claim 1, wherein the client comprises:
a query module, to send the query request and the downloading request to the skin package server, and receive the skin package returned by the skin package server;
a local storage module, to store the downloaded skin package;
a selecting module, to display information related to the downloaded skin package stored in the local storage module which is provided for selection of the user; and
a skin changing module, to change the interface skin according to the downloaded skin package selected by the user.

6. The system of claim 5, wherein the skin changing module comprises:
a skin changing interface, to process a skin changing request from the user according to the selection of the user;
a loading module, to load the downloaded skin package selected by the user, wherein the downloaded skin package is taken as skin resources;
an interface creating module, to create an interface element according to the skin resources; and
an interface element storage module, to store each created interface element.

7. A method for changing interface skin, comprising:
sending a query request periodically, and obtaining information related to a newly added skin package;
initiating a downloading request according to selection of a user to download a skin package stored in the skin package server; and
changing interface skin according to a downloaded skin package.

8. The method of claim 7, wherein before changing the interface skin according to the downloaded skin package, further comprising:
creating an interface element according to the downloaded skin package, and storing the created interface element in local;
wherein the interface skin is changed without restarting a application program.

9. The method of claim 7, wherein before obtaining the information related to the newly added skin package, further comprising:
recording index information of the newly added skin package; and
obtaining the information related to the newly added skin package comprises:
obtaining the information related to the newly added skin package according to the index information of the newly added skin package.

10. The method of claim 9, wherein the index information of the newly added skin package comprises a time stamp of uploading the newly added skin package to a skin package database;
obtaining the information related to the newly added skin package according to the index information of the newly added skin package comprises:
obtaining, according to the time stamp of uploading the newly added skin package to the skin package database, the information related to the newly-added skin package which is newly added during an interval between two queries, and when determining, through querying, that there is the information related to the newly added skin package, recording the index information of the newly added skin package.

11. The method of claim 7, wherein changing the interface skin according to the downloaded skin package comprises:
storing the downloaded skin package, displaying the information related to the downloaded skin package which is stored to be selected by the user, and changing the interface skin according to the downloaded skin package selected by the user.

12. The method of claim 11, wherein changing the interface skin according to the downloaded skin package selected by the user comprises:
processing a skin changing request from the user according to the selection of the user, loading the downloaded skin package selected by the user, wherein the downloaded skin package selected by the user is taken as skin resources, and creating an interface element according to the skin resources; and
storing each created interface element.
